(19) United States
(12) Patent Application Publication
(10) Pub. No.: US 2005/0185052 A1
(43) Pub. Date: Aug. 25, 2005

(54) Automatic collision triggered video system

(76) Inventors: Vijay S. Raisinghani, Schaumburg, IL (US); Venkat Narayanan, Barrington, IL (US)

Correspondence Address: MOTOROLA, INC., 1303 EAST ALGONQUIN ROAD, IL01/3RD, SCHAUMBURG, IL, 60196, US

(21) Appl. No.: 10/786,635

(22) Filed: Feb. 25, 2004

(51) Int. Cl. H04N 7/18

(52) U.S. Cl. 348/148; 348/143

(57) ABSTRACT

A video recording system is responsive to an automotive controls system. The video recording system includes a video camera, capable of capturing either still photos or video footage. The video camera may be integral to the interior of a vehicle, for example in a navigation unit, or may be coupled to a detachable electronic device like a cellular telephone. The video recording system communicates with the controls system by either hard wire link or wireless link. The controls system includes one or more sensors capable of detecting when a collision has occurred. One such sensor is an airbag deployment sensor. When the controls system detects that a collision has occurred, it sends an actuation signal to the video recording system, thereby causing the video recording system to begin capturing either photos or video footage. This video footage may then be stored locally or transmitted to a remote server. In one application, the video footage may be used by emergency personnel to determine the conditions inside the vehicle immediately following an accident.

### BACKGROUND

1. Technical Field

This invention relates generally to video recording systems for use in vehicles, and more particularly to a video or audio recording system that is actuated when a vehicular collision is detected.

2. Background Art

As anyone who has ever been in a serious automobile accident knows, once the accident has occurred, the response time of emergency personnel can become a life or death matter. When emergency personnel arrive quickly, even seriously injured people have a strong chance of survival. If there is a delay in notifying the authorities, however, the chances of survival become greatly diminished.

In addition to response time, accuracy of information is critical. In other words, it is imperative that the emergency personnel know exactly what type of accident has occurred so that they may deploy the proper emergency equipment. For example, a person who has suffered a concussion may be adequately served by an ambulance alone. A person that is trapped in a mangled car, and who happens to be bleeding profusely, may require additional equipment including a helicopter and jaws of life. In short, it is essential that the authorities know exactly what injuries have been sustained prior to dispatching emergency equipment.

At odds with this need for speedy, accurate information is the accident victim's condition immediately following the accident. In many accidents, the motorists may be rendered unconscious, and therefore unable to describe the accident scene to the authorities. While vehicular navigation systems like OnStar® may relay the time and location of an accident in short order, these systems are unable to relay information as to the severity or type of accident.

One prior art solution to this lack of information is the “black box”. Similar to the recording devices found in airplanes, the prior art solution is to equip the vehicle with cameras which continuously record video footage. This video footage is the stored in a collision resistant, non-volatile memory device locked away in the black box. When an accident occurs, the black box “freezes” the video data stored in the box, and then optionally transmits this data to a central server.

The problem with this prior art solution is threefold: First, it is expensive. Video cameras must be mounted in the car, and must continually record video footage. Additionally, the black box is required to store the footage. Such a system may add significant cost to the overall price of the car. For this reason, consumers may be tempted to pass on purchasing the option, thereby preventing the emergency personnel from getting the information they so desperately need.

Second, such a system can be personally intrusive. People often apply make-up or comb their hair while in the car. They may not want a video camera recording them prior to grooming.

Third, such a system constantly consumes power, thereby reducing life span of the batteries. This is especially true when the vehicle's engine is not running. The constantly running video cameras act as a constant load on the battery. Such constant depletion of the battery will reduce the cycle life of the battery, and increase the overall cost of the system as a user must replace the batteries more frequently. This increased expense, as well as the decreased efficiency, may cause consumers to decline in purchasing the option.

There is thus a need for an improved accident information system that is lower in cost, less intrusive and which does not detract as much from the vehicle's efficiency.

### BRIEF DESCRIPTION OF THE DRAWINGS

FIG. 1 illustrates a block diagram of a video recording system in accordance with the invention.

FIG. 2 illustrates one exemplary embodiment of a video recording system in accordance with the invention.

FIG. 3 illustrates a block diagram of a vehicle navigation unit in accordance with the invention.

FIG. 4 illustrates a vehicle equipped with a video recording system in accordance with the invention.

FIG. 5 illustrates a network across which video footage may be transferred to a remote server upon actuation resulting from a collision being detected.

FIG. 6 illustrates an interior of a vehicle that has been equipped with a video recording system in accordance with the invention.

FIG. 7 illustrates the interior of the vehicle of FIG. 6 after an accident as occurred.

FIG. 8 illustrates a method of recording video footage in accordance with the invention.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

This invention includes a video recording system that is actuated by a vehicular collision detection system. For example, in a vehicle equipped with airbags, when the vehicle experiences a collision, the airbags deploy. This deployment is detected by the vehicle's control system, which includes control circuitry, and may include a microcomputer. In one embodiment of this invention, when such an event occurs, the vehicle's control system transmits a video actuation signal to a video recording system that includes a video camera. Note that while the invention, as described herein, talks of recording “video footage”, audio footage may be simultaneously captured as well. The video recording system may be disposed either integrally with the car or in a detachable device like a cellular telephone.

Once this video actuation signal is received, the video camera begins recording video footage. Where the camera is positioned such that the lens is directed towards the interior of the car, the video footage will include the condition of the vehicle's cabin, as well as the visible condition of the passengers. This video footage may then be either stored locally or transmitted via wireless link to a remote server. When transmitted to a remote server, the video footage will be accessible by the proper emergency authorities.

As stated, it is the actuation of a collision sensor that initiates the recording of the video footage. By delaying the recording until after the accident has occurred, power is conserved in the video recording unit. Additionally, only footage of the accident scene is recorded, thereby sparing emergency personnel from the task of sorting through superfluous, pre-accident and non-accident footage. This results in a more timely, efficient and effective delivery of information as compared to the prior art.

Any number of collision detection mechanisms may be employed to actuate the video recording system. As noted above, airbag deployment works well as an actuation means. Other possible alternatives include the following: First, seatbelt monitors may be used. When an accident occurs, inertia generally causes the passenger to be thrown from the seat. This throwing action causes the seatbelt to unwind rapidly. This rapid unwinding is stopped, thereby stopping the passenger from becoming a projectile, by a locking mechanism. Actuation of the seatbelt locking mechanism may thus be used as a trigger for the video recording system.

Second, an accelerometer may be used. Accelerometers are electronic devices that detect sudden changes in acceleration. By coupling the accelerometer either to the vehicle's microcomputer or to the video camera itself, the accelerometer may be employed as a trigger.

Third, the speedometer may be used as a trigger. When an accident occurs, the speed of a vehicle often goes from some non-zero value to zero in a very short amount of time. Such sudden changes in speed, detectable by the vehicle's microcomputer, may be used as the triggering mechanism for the video camera. Firmware filters may be added to prevent false actuation.

Fourth, acoustic sensors may be employed. When accidents occur, two things generally happen. There is often a loud “crashing” sound, either from bending metal, cracking plastic or breaking glass. Additionally, acoustic vibrations from deforming metal propagate throughout the various automotive parts. By including acoustic sensors that detect sudden changes in the acoustic vibrations of either the air or the vehicular parts, these sensors may be used to trigger the video recording system.

Fifth, engine sensors may be used. The vehicular microcomputer in most all cars includes a tachometer sensor to measure the revolutionary speed of the drive shaft. When an accident affecting the workings of the engine occurs, the tachometer rapidly changes from a non-zero value to zero. Additionally, the key remains in the “on” position, thereby alerting the vehicular microcomputer to the fact that the driver did not turn off the engine. Such situations may be used to trigger the video recording system, as they are indicative that an accident has occurred.

Sixth, automotive systems sensors may be used as a triggering mechanism. The vehicular microcomputer monitors the various vehicular systems like the cooling system, the oil system and the fuel system. When accidents occur, such systems often get punctured or destroyed, thereby resulting in a sudden loss of antifreeze, oil or gas. When the vehicular microcomputer detects such a sudden fluid loss, it may trigger the video recording system. Additionally, newer vehicles come equipped with specially designed collision sensors. These collision sensors, where included, serve as an excellent triggering means.

Seventh, a gyroscopic sensor may also be used. Gyroscopes are known in the art for being able to detect changes in alignment relative to velocity. Such devices are thus able to detect when a vehicle “rolls over” as a result of an accident. Such sudden, unexpected changes in alignment may be used to trigger the video recording system.

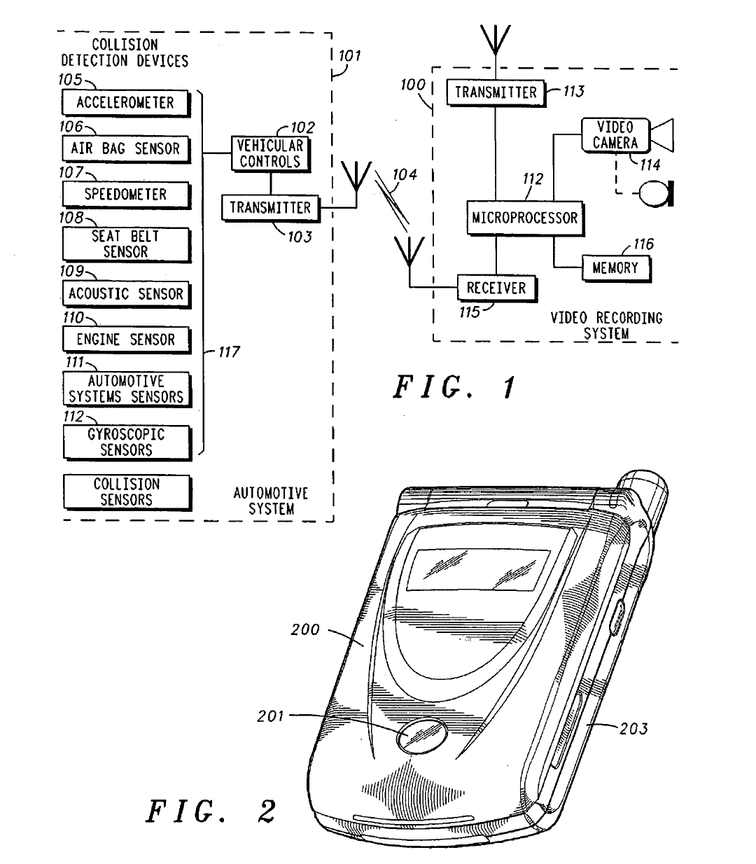

Referring now to FIG. 1, illustrated therein is a block diagram of a video recording system in accordance with the invention. The automotive electronic system 101 transmits an actuation signal 104 to the video recording system 100. The transmission of the actuation signal 104 may be through a conductor, like a wire, where the video recording system 100 is integrally mounted in the car. One such integral mounting is when the video recording system 100 is integrated into a vehicular system like an on-board navigational unit or other electronics system.

In an alternate embodiment, the video recording system 100 may be included with a detachable device, like a cellular telephone for example. In this situation, the transmission of the actuation signal 104 may be either through a hard-wire link or wireless link. A hard-wire link may be employed when the cellular telephone is coupled to a vehicular cradle that is coupled to the vehicles electronic control system. If, on the other hand, the car is loosely disposed within the car, the transmission of the actuation signal 104 may be through a wireless, radio-frequency (RF) communications link like Bluetooth, for example.

Within the automotive system 101, a means for sensing when a vehicular collision occurs 117 is provided. The means for sensing when a vehicular collision occurs 117 could be any of the triggers listed above. In other words, the means for sensing a vehicular collision occurs 117 may be selected from the group consisting of accelerometers, airbag actuation mechanism, speedometers, collision sensors, seat belt monitors, acoustic sensors, engine sensors, gyroscopic sensors and automotive systems sensors. These devices may be employed either independently or in combination.

The various sensors 117 are coupled to the microcomputer 102 that serves as the vehicle's nerve center or control center. When one of the sensors 117 is actuated, the microcomputer 102 detects that a collision has occurred. The microcomputer 102 then actuates a means for transmitting a video actuation signal 103. As noted above, this transmitter 103 may be as simple as a copper wire coupling the automotive system 101 to the video recording system 100. In the alternative, where a wireless link is required, the transmitter 103 may include a frequency modulation device, power amplification and an antenna.

There is a corresponding means for receiving a video actuation signal 115 on the video recording system 100. This receiver 115 receives the actuation signal from the automotive or vehicular controls system 101 and passes it along to a microprocessor 112 disposed within the video recording system 100. Within the microprocessor 112, an electronic switch that serves as a triggering means that couples the means for sensing when a vehicular collision has occurred 117 to the video camera 114. When the video actuation signal 104 is received, the switch actuates, thereby causing the video camera 114 to begin recording video footage. In other words, when the means for sensing when a vehicular collision occurs 117 is actuated, the video camera (note that there may be a single camera or a plurality) begins recording the video footage. The video camera 114 may also include a remotely actuatable control mechanism, so that the alignment and direction, and thus the viewable subject matter, may be controlled remotely.

The video recording system 100 further includes a memory device 116 that serves as a means for storing a predetermined amount of video footage recorded by the video camera 114. Where the video recording system 100 comprises either a vehicular navigation unit having transmission capabilities or a cellular telephone, a transmission device 113 will be present to allow the device to connect with a cellular or other wireless network. In such situations, the video recording system 100 may transmit a stream of video footage to a remote server. The remote server may either store the stream of video footage, or it may simply display the video footage on a means for displaying the video footage, like a television or computer, disposed at the remote location.

In this case, the memory 116 may need to hold only a portion of the video footage, thereby acting as a buffer between the output of the video camera 114 and the transmission device 113. When the transmission device 113 is not present, the memory 116 will be larger to hold a sufficiently long length of video footage to obtain relevant accident information. Note that while the microprocessor 112 may be shared between the camera 114 and other devices, both the memory 116 and microprocessor 112 may be incorporated within the video camera 114 when the video camera 114 is an independent unit.

Turning now to FIG. 2, illustrated therein is one exemplary embodiment of a video recording system in accordance with the invention. A cellular telephone 200 is provided having a camera 201 coupled thereto. The camera may be capable of taking either still photos or motion video footage. Disposed within the phone are the transmitter 113, microprocessor 112 and memory 116 as described in FIG. 1. With a cellular phone 200, the receive and transmit means are both accomplished through an antenna 202 where the communications are wireless. If the phone 200 is coupled to a cradle, an electrical connector disposed on the base 203 of the phone 200 facilitates hardwire communications to and from the phone 200.

Turning now to FIG. 3, illustrated there is a block diagram of a vehicle navigation unit 300 in accordance with the invention. Many automobiles today, like the Honda Accord® with its Navi™ system for example, offer conventional navigational systems. Such systems are generally mounted in the center of the dashboard of the vehicle. These conventional navigation systems have input devices, microprocessors, and wireless transmitters and receivers for uploading and downloading information to a remote server.

The navigation unit 300 in accordance with this invention includes a video camera 301 that may be actuated by the collision detection means. As the devices are mounted in the center of the dashboard, the camera 301 of the navigation unit 300 may be positioned such that a clear, panoramic view of the interior may be seen. The camera 301 may either be mounted behind a visual screen of the navigation unit 300, or it may additionally be included as a feature near the screen. In either event, the camera 301 is preferably positioned within the confines of the navigation unit's housing so as to be protected in the event that the overall vehicle is damaged in a collision.

At the heart of the navigation unit 300 is a microcomputer 302. The navigation unit 300 may further include a wireless communication device 303, a GPS module 304, a memory 305, a memory 306 to navigational information and maps downloaded from a service center, a camera 301, a memory for storing video information 310, an on/off button 307 to activate/deactivate the system, and a microphone 308 and output 309 for hands-free operation.

In one embodiment, the wireless communication device 303 includes a transmitter to transmit cellular wireless communications such as AMPS, CDMA, GSM or TDMA. The wireless communication device 303 may also be configured to transmit by other wireless communications such as a satellite communication. The wireless communication device 303 includes a receiver to receive and decode the digital data transmitted by the service center. The receiver may be configured to receive digital cellular communications such as CDMA, GSM or TDMA. The receiver may also be configured to receive other types of wireless communications such as those transmitted by satellites.

The navigation unit 300 may further include sensors 311 or inputs from various sensors already existing on the vehicle. The types of sensors 311 that may be applicable for the navigation unit 300 are a speed sensor and a direction or heading sensor. Additionally, the collision sensors mentioned above may be coupled to the navigational unit to actuate the camera 301.

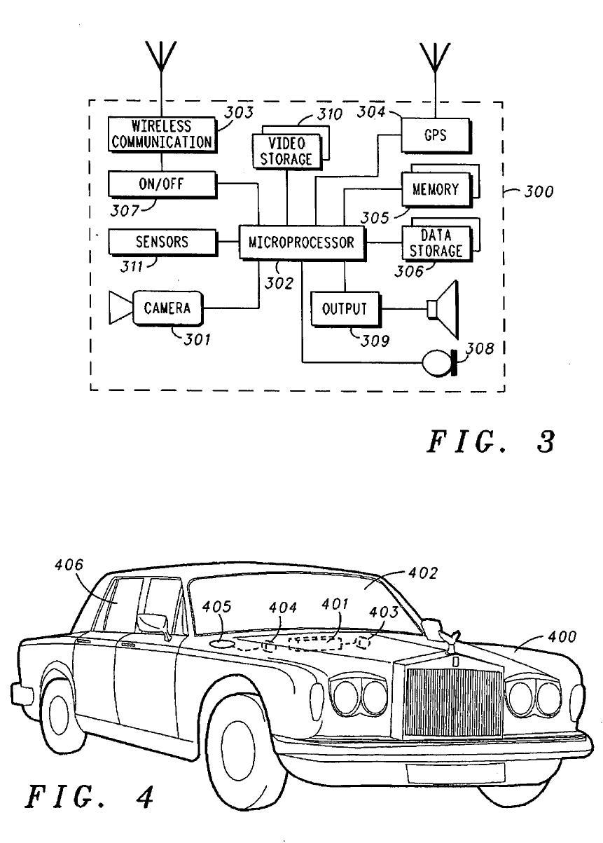

Turning now to FIG. 4, illustrated therein is a vehicle 400 equipped with a video recording system in accordance with the invention. The vehicle 400 includes an automotive controls unit 401 which is coupled to at least one collision sensor. In the embodiment of FIG. 4, the controls unit 401 is coupled to a plurality of sensors 402,404. These sensors may be selected from any of the collision sensors described above, including airbag deployment sensors and accelerometers to name a few. Additionally, sensors may coupled to the windshield 402 or windows 406 for sensing breaking or shattered glass.

When the sensors 402,404 cause the controls unit 401 to detect a collision, the controls unit 401 acutates a video camera 405 disposed within the vehicle. As mentioned above, the video camera 405 may be integrated with a detachable device, like a cellular phone, and may be either loosely disposed within the car or coupled to a cradle. Further, the video camera may be integral to an automotive system like the navigation unit, in which case it would be integral to the automobile.

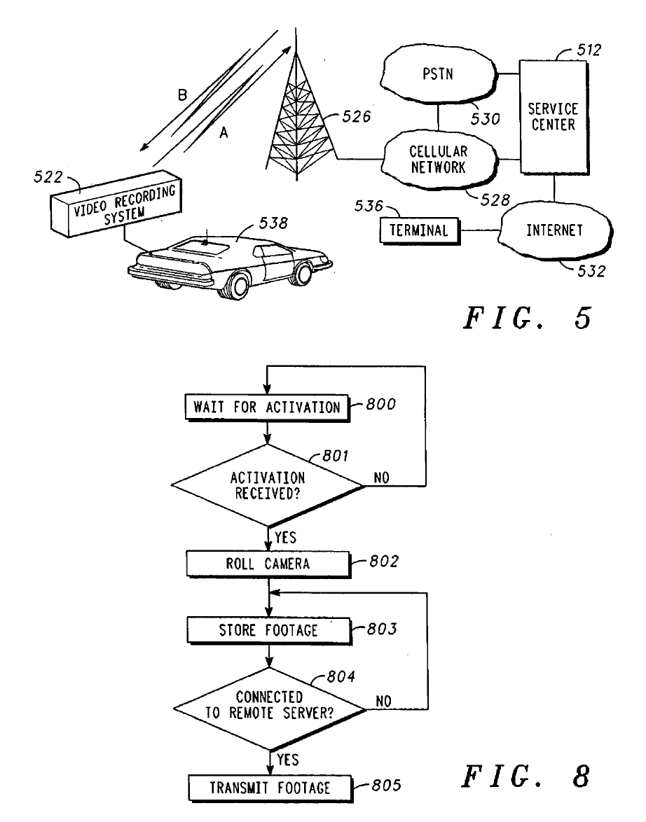

Turning now to FIG. 5, illustrated therein is a network across which video footage may be transferred to a remote server upon actuation resulting from a collision being detected. Generally, the network 520 includes the video recording system 522 and a remote service center 524. The video recording system 522 and the service center 524 may communicate with each other via wireless communications, illustrated by communication arrows A and B.

The communications may take place as follows: the communication A is a cellular wireless communication that is transmitted to a base station antenna 526, through a cellular network 528 and a public switched telephone network (PSTN) 530, and to the service center 524.

Those of ordinary skill in the art, having the benefit of this disclosure, will appreciate that many possible wireless communication methods may be used for communications from the video recording system 522 to the service center 524. In one embodiment, the communications are via a cellular wireless communication such as AMPS, CDMA, GSM or TDMA. The transmission from the video recording system 522 to the service center 24 may also be made by other wireless communications such as a satellite communications.

The communication B is a cellular wireless communication that is sent through the public switched telephone network (PSTN) 530 and cellular network 528 and transmitted by the base station antenna 526 to the video recording system 522. Again, those of ordinary skill in the art, having the benefit of this disclosure, will appreciate that many possible wireless communication methods may be used for communications from the service center 524 to the video recording system 522. In one embodiment, the communication is via a digital cellular wireless communication such as CDMA, GSM or TDMA. The transmission from the service center 524 to the video recording system 522 may also be made by other wireless communication such as a satellite communications.

Additionally, the network 520 may be set up to allow alarms to be triggered upon the actuation of the video camera via the Internet 534 and a remote device 536. For example, direct video feeds may be delivered to emergency personnel. Such a communication of video footage would enable the emergency personnel to be more prepared for the accident scene.

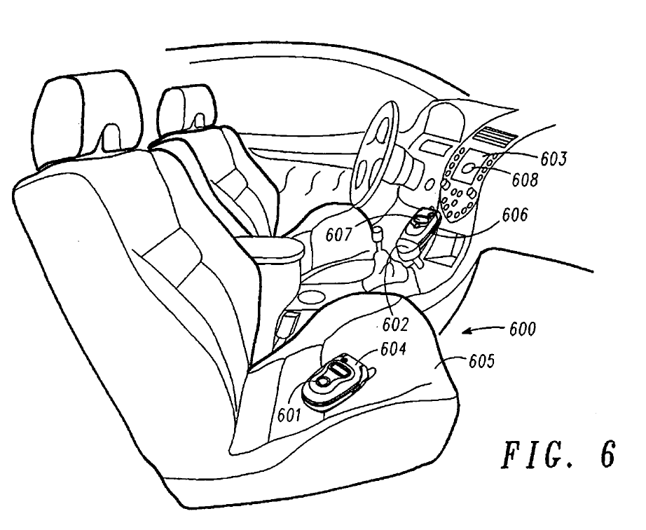

Turning now to FIG. 6, illustrated therein is the interior of a vehicle 600 that has been equipped with a video recording system in accordance with the invention. FIG. 6 illustrates three of the many possibilities of locations for the video camera that is to be actuated upon the vehicle sensing that a collision has occurred. In one exemplary location, a video camera disposed in a cellular telephone 601 has been loosely disposed on the seat 605. Note that the user has strategically positioned the cellular telephone/camera combination 601 such that the camera 604 is facing up from the seat 605, so as to be able to capture video footage of the interior. In this particular configuration, communication between the cellular telephone and video camera 601 and the vehicle's control and sensor system will be by wireless link, as there is no hardwire link between the two.

In an alternate location, a cellular telephone with a video camera 606 has been coupled to a cradle 602 within the vehicle. The cradle 602 is designed such that the camera 607 is facing the interior of the vehicle, so as to properly record the interior conditions when actuated by a collision being detected. In this particular configuration, communication between the cellular telephone and video camera 606 and the vehicle's control and sensor system may be either by wireless link or hardwire connection, as there may be a hardwire link from the automotive control system to the cradle 602 to the phone 606.

In a third alternate location, the camera 608 has been incorporated into the electronics of the vehicle. In FIG. 6, the electronics of incorporation include the navigation unit 603. Such is advantageous, because not only can the navigation unit 603 record video footage of the interior of the car, but it may also denote the location of the accident from its GPS unit. In this particular configuration, communication between the video camera 603 and the vehicle's control and sensor system will be by hardwire link, as the unit is integral to the vehicle's electronics system.

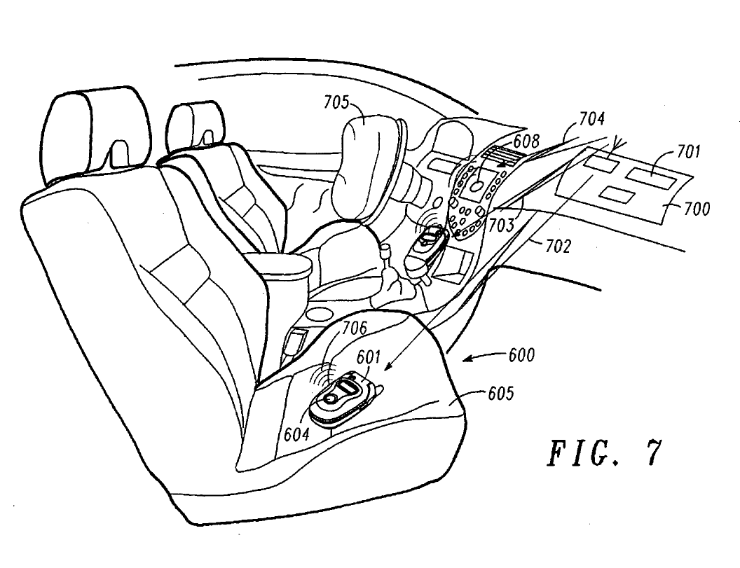

Referring now to FIG. 7, illustrated therein is the interior of the vehicle 600 of FIG. 6 after an accident as occurred. In this exemplary embodiment, the sensor causing actuation of the video camera is the airbag deployment. As shown, the airbag 705 has deployed as a result of the accident. This deployment has actuated an airbag sensor 701 within the control unit 700. The control unit 700, in turn, then actuates video recording by the video recording system. As with FIG. 6, three exemplary locations for the camera have been illustrated. In practice, the user would most likely select only one location, although multiple locations may be simultaneously used. It will additionally be clear to those of ordinary skill in the art having the benefit of this disclosure that locations other than those shown may be equally employed.

With respect to the loosely positioned cellular telephone 601, actuation signal 702 is transmitted from the control unit 700 to the cellular phone 601. This signal 702 actuates the video camera 604. The video camera 604 then begins recording video footage, loosely represented by light rays 706. In similar fashion, actuation signal 703, transmitted by either hardwire link or wireless link, causes phone/camera combination 606 to begin recording video footage. Likewise, actuation signal 704 causes the integral camera 608 to begin recording video footage.

Referring now to FIG. 8, illustrated therein is a method of recording video footage in accordance with the invention. At step 800, the video recording system of the invention awaits an actuation signal. If all goes well, and the vehicle avoids having a collision—a good thing for the driver and passengers—the video camera never leaves step 800. This monitoring step is shown as step 801.

If, however, an unfortunate series of events results in a collision, the camera is actuated by the vehicular control system at step 802. The video footage is stored, either remotely or locally or both, at step 803. The video recording system checks to see if a communications link to a remote server exists at step 804. If so, video footage may be transmitted thereto at step 804. If not, the video footage will be stored locally at step 803.

While the preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims.

1. A video recording system, comprising:
a. a means for sensing when a vehicular collision occurs;
b. at least one video camera;
c. a means for storing a predetermined amount of video footage recorded by the at least one video camera; and
d. a triggering means coupling the means for sensing when a vehicular collision occurs and the at least one video camera;
wherein when the means for sensing when a vehicular collision occurs is actuated, the at least one video camera begins recording the video footage.

2. The system of claim 1, wherein the means for sensing when a vehicular collision occurs is selected from the group consisting of accelerometers, air bag actuation mechanisms; speedometers, collision sensors, seat belt monitors, acoustic sensors, engine sensors, gyroscopic means and automotive systems sensors.

3. The system of claim 2, wherein the system further comprises a microphone for recording audio footage.

4. The system of claim 2, wherein the means for storing the predetermined amount of video footage is coupled to the at least one video camera by a hard-wire link.

5. The system of claim 2, wherein the means for storing the predetermined amount of video footage is coupled to the at least one video camera by wireless link.

6. The system of claim 5, further comprising at least a second means for storing video footage, wherein the at least a second means for storing video footage is disposed at a remote location.

7. The system of claim 5, further comprising a means for displaying the video footage, wherein the means for displaying the video footage is disposed at a remote location.

8. The system of claim 5, wherein the video footage is streamed across the wireless link.

9. The system of claim 5, wherein the video camera comprises a remotely actuatable control mechanism.

10. The system of claim 1, wherein the video camera comprises a cellular telephone.

11. The system of claim 1, wherein the video camera comprises a vehicular navigation unit.

12. A video recording system for capturing video footage of an accident scene, the system comprising:
a. a video camera comprising:
i. at least one microprocessor;
ii. memory for storing at least a portion of the video footage therein; and
iii. a means of receiving a video actuation signal;
b. a vehicular control system comprising:
i. a means for detecting a collision; and
ii. a means for transmitting a video actuation signal;
wherein when the means for detecting a collision detects that a collision has occurred, the means for transmitting a video actuation signal transmits a video actuation signal, and upon the means for receiving a video actuation signal receiving the video actuation signal, the microprocessor causes the video camera to begin recording the video footage.

13. The system of claim 12, wherein the means for sensing when a vehicular collision occurs is selected from the group consisting of accelerometers, air bag actuation mechanisms, speedometers, collision sensors, seat belt monitors, acoustic sensors, engine sensors, gyroscopic sensors and automotive systems sensors.

14. The system of claim 13, further comprising a microphone for recording video footage.

15. The system of claim 14, wherein the video camera comprises a cellular telephone.

16. The system of claim 14, wherein the video camera comprises a vehicular navigation unit.

17. A method of recording video footage of an accident scene, the method comprising the steps of:
a. upon a vehicular collision occurring, receiving a video actuation signal from a vehicular diagnostic system capable of detecting that the vehicular collision has occurred;
b. initiating a video recording system; and
c. storing video footage recorded by the video recording system.

18. The method of claim 17, further comprising the step of transmitting the video footage to a server.

19. The method of claim 17, wherein the video recording system comprises the system of claim 1.

20. The method of claim 17, wherein the video recording system comprises the system of claim 12.
